(19) United States
(12) Patent Application Publication
(10) Pub. No.: US 2005/0033859 A1
(43) Pub. Date: Feb. 10, 2005

(54) Method for controlling access to a communication network

(76) Inventor: Martin Karsten, Ontario (CA)

Correspondence Address: MILDE & HOFFBERG, LLP, 10 BANK STREET, SUITE 460, WHITE PLAINS, NY, 10606, US

(21) Appl. No.: 10/503,177

(22) PCT Filed: Jan. 24, 2003
(86) PCT No.: PCT/DE03/00190

(30) Foreign Application Priority Data
Feb. 1, 2002 (DE) 10204089.3

(51) Int. Cl. G06F 15/16

(52) U.S. Cl. 709/233; 709/241

(57) ABSTRACT

In a method for access control to a communications network with internal nodes and access nodes whereby each of the access nodes consists of an ingress node and an egress node, and which sends and receives data packets from connected equipment and/or other networks whereby the internal nodes using routing algorithms direct the data packets from an ingress node to an egress node, and whereby the internal nodes provide data packets with a load-dependent mark, it is provided that the egress nodes count the data packets and the marks contained therein arriving from the communications network separately by ingress node, and thereby form load reports from the particular time interval during which the counting occurs, and that data for access control are derived from the load reports.

### TECHNICAL FIELD

The invention relates to a method for controlling access to a communications network with internal nodes and access nodes whereby each of the access nodes consists of an ingress node and an egress node, and directs data packets in and out from connected equipment and/or other networks whereby the internal nodes direct the data packets according to a routing algorithm from an ingress node to an egress node, and whereby the internal nodes provide data packets with a load-dependent mark.

### STATE OF THE ART

In order to identify overloads or congestion in the internet, it was revealed by Kudangode K. Ramakrishnan, Sally Floyd, and David Black, IETF RFT 3168: The Addition of Explicit Congestion Notification (ECN) to IP, September 2001, that a mark consisting of a correspondingly-set bit is added to those data packets that have passed through at least one internal node and that have had an overload identified. Upon reception of the data packet at an egress node, it may be determined whether at least one of the nodes and links used to transfer these data packets is highly loaded or overloaded. The above-mentioned document and those of the IETF (Internet Engineering Task Force) mentioned below may be found on the Internet at the address http://www.ietf.org/rfc.html.

In the known procedures for load-dependent marking, the term load refers to the transmission load at the output link rather than the computational load of the forwarding node. This includes the implicit assumption that the forwarding capacity of the forwarding node is always adequate, and the high load becomes an overload if the sum of the traffic exceeds the capacity of a specific link.

The known procedures for load-dependent marking may be subdivided into:
Queue oriented (marking occurs when the queue exceeds specified fill levels),
Rate-oriented (marking occurs dependent on the traffic rate), and
Virtual queue (here, a virtual system is simulated in which the transfer capacity is less than in the real system; when the queue in the virtual system exceed specified fill levels, marking occurs in the real system).

It is therefore the object of the invention to use the information included in such marks to improve access control to the Internet or in other packet-transmitted networks.

This object is achieved by the invention in that the egress nodes count the data packets and the included marks arriving from the communications network separately by ingress node, and form load reports based on the time interval during which the count is performed, and that data for access control may be derived from the load reports.

This method has the advantage that information for predictions regarding the load status of the communications network is made available, and used for access control, whereby only a very minor or no alteration of the internal nodes regarding hard- or software with respect to the known explicit-congestion-notification is required.

An advantageous embodiment of the invention consists of accepting a new request through the access control if the reported load does not exceed a preset threshold value; otherwise, the request is rejected.

Another embodiment of the invention provides that the load reports are transferred to ingress nodes, and that the quantity of data packets determined for the egress node sending the load report is limited in the ingress node receiving the particular load report. With this embodiment, an effective access control is permitted so that threatening congestion to the communications network or portions thereof may be prevented in time. It may also be provided that no limiting occurs if the number of marks with respect to the number of data packets drops below a certain pre-determined lower threshold.

The time interval used for the count may be dynamically adapted to the particular circumstances. For example, the number of data packets may be specified dynamically as necessary so that the time interval may result from it.

Another form of access control published by Jonathan Turner: “New Directions in Communications”, IEEE Communications Magazine, No. 16 Year 24, October 26 as a token-bucket regulator (TBR) may be significantly improved by procedure based on the invention.

For this, a further developed embodiment of the invention controls the routing of data packets into the communications network is controlled by means of a Token-bucket regulator (TBR) in the ingress nodes using the parameters bucket depth, filling rate, and peak rate, whereby the token rate is calculated using the previous token rate, the interval between a particular data packet and the previous data packet, and a specified filling rate and that the load reports are taken into account during calculation of the token rate.

An advantageous embodiment of this expansion consists of the fact that data packets that successfully pass the TBR are provided with an ECT mark, while non-registered data packets or an excess of data packets are passed along without ECT marking.

This embodiment of the invention allows a minimum rate for prioritized participants in that the token rate is calculated as follows:
t_{new}=i·s·r+t,
where t is the previous token rate, i is the interval between the current and the previous data packet, s is a value obtained form the load report, and r is a minimum rate.

For this reason, it is advantageously provided that s=(u−e)/l is calculated, where l is the current load estimation, u is a threshold value for the access control and e is safety margin. This prevents a very slow data rate for data flows from being requested, and then a significantly higher data rat from being transmitted. The network might thus become used to its capacity. Since other ingress nodes or egress nodes cannot distinguish such a load from the basic load of the data flows, new demands are eventually refused although the existing data flows could actually have space.

It is advantageous for the scaling value s reported to the TBR to be set lower than the load estimation actually contained on the current load report multiplied times the threshold value for access control. Otherwise, elastic traffic flows with low rate parameters could prevent the system from accepting new traffic flows even if the required resources were free.

Upon use of a receiver-initiated quality of service signaling protocol such as described, for example, by Robert Braden, Lixia Zhang, Steve Berson, Shai Herzog, and Sugih Jamin. RFC 2205—Resource ReSerVation Protocol (RSVP)—Version 1 Functional Specification, Standards Track RFC, September, 1997, the load report may be transferred within a data packet indicating a reservation at the particular ingress node.

If such data packets are not available frequently enough, it may also be provided that the load report is transferred to the particular ingress node within its own data packet.

Using known options to control the traffic in the Internet (e.g., RSVP), in which after a report of need of an ingress node to an egress node, and then a reservation of the data rate occurs from the egress node, the method according to the invention may be so applied that the actual data rate is estimated based on the load report, and that the load estimated for the access control is adjusted depending on the difference between the reserved data rate and the estimated actual data rate.

This embodiment example may be so designed that the estimated load is calculated as follows:
l=(m/p)·((a+R)/u),
where l is the estimated load, m and p are the numbers of marks and data packets contained in the load report a is the data rate assignment, R is the demand, and u is the usage rate of the load report derived from the number of bytes and the time-interval information.

This embodiment example takes into account the newly-introduced reservation, and corrects the available load estimation corresponding with the above-mentioned, i.e., it estimates the future load including the influence of the new reservation.

Further, reserved but not used data rates may be taken into account by means of controlled over-booking. Specifically, it may be provided here that the adjusted estimated load l* be calculated as follows:
L*=l·[α(c−u)+u]/u
where l is the estimated load along a path, c is the accumulated reserved data rate along this path, and u is the actual measured data rate, and where α determines to what extent the unused data rate (c−u) influences the calculation.

Thus, for example, for α=l l*=l·c/u. i.e., the unused data rate is completely taken into account. The estimation is therefore very pessimistic. If α=0, which results in l*=l, the unused data rate is not taken into account at all, i.e., the estimation is therefore very optimistic. Thus, with α, assumptions may be coded regarding a potential over-booking of resources.

It is possible that the communications network also passes data that are not subject to any access control, whereby however it must be guaranteed that these data match their data rate to CE marking (such as classical TCP/ECN) or that they bear no ECT marks.

In the above-mentioned marking procedure, in a first step, an algorithm is applied, and in a second step, it is decided whether a data packet is marked or discarded (depending on the ECT bit). Based on an expanded embodiment of the invention, it is first decided based on the ECT bit which algorithm will then be applied, whereby with the ECT bit set, a rate-oriented algorithm is used, and with an ECT bit not set, a queue oriented algorithm is applied.

This expanded embodiment allows a certain transmission of non-registered data packets whereby these data packets are first discarded by means of the queue oriented algorithm under conditions of increased load.

In a further port development of the invention, the rate-oriented algorithm may provide the data packet with a marking rate that results exponentially from the current degree of usage, e.g., for a degree of usage X via m(x)=[exp(k−x)−1]/[exp(k)−1] with a weighting factor of k. This makes it possible to make conclusions from the load status of the path regarding the degree of usage of the most heavily-used node, even if the multiplication of the marking probabilities are added back.

Only one path is used at a time in the packet-forwarded networks available at that time between an ingress node and an egress node. For this, it is adequate within the egress node to separate by ingress nodes. There are, however, routing algorithms possible according to which several paths at a time may be used between an ingress node and an egress node, for which it is provided based on an expanded embodiment of the invention that the counting further be performed separately, and that the access control is undertaken by path.

The forwarding nodes currently in use on the Internet forward the data packets based on the queue principle, i.e., the data packets to be sent are directed at the output of a particular link through a FIFO. Forwarding nodes have been recommended that undertake a difference forwarding of the data packets, e.g., the differentiated Services Model of the IETF in which it is decided based on fields in the IP header between several traffic classes. The procedure based on the invention may be applied in both cases, preferably in the second case separately per traffic class.

### BRIEF DESCRIPTION OF THE ILLUSTRATIONS

Embodiment examples of the invention are described in detail in the following, and are shown in the illustrations using several Figures which show:

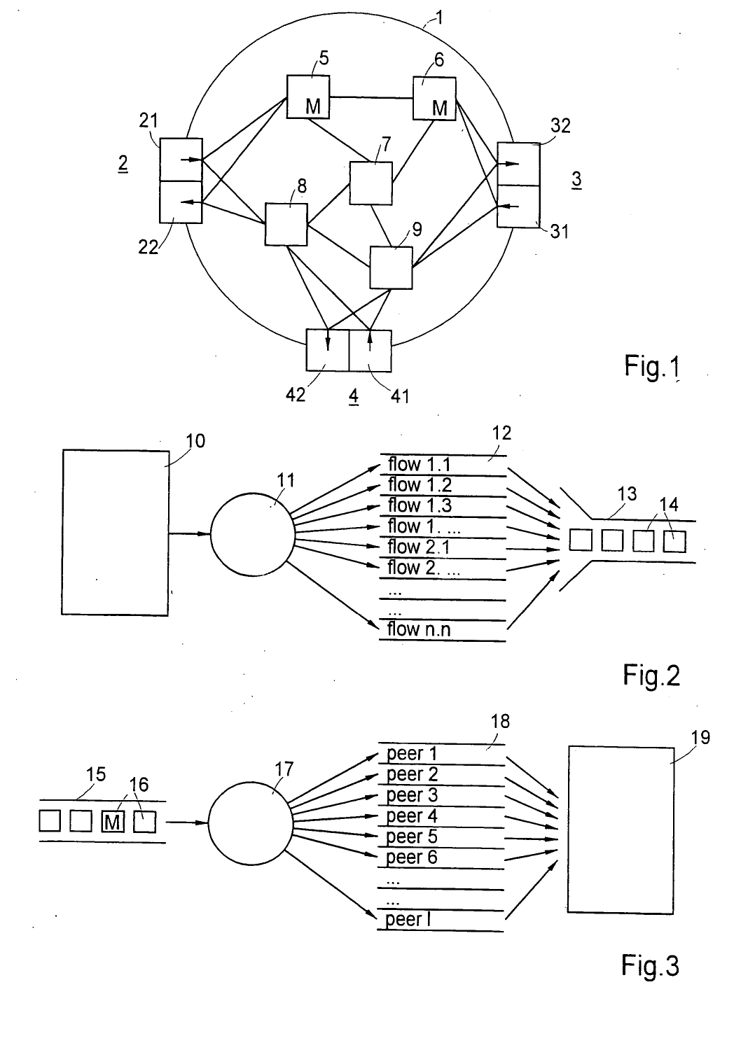

FIG. 1 shows parts of a communications network to explain the procedure based on the invention.

FIG. 2 shows an ingress node, in schematic representation.

FIG. 3 shows an egress node, in schematic representation.

### DESCRIPTION OF THE PREFERRED EMBODIMENTS

FIG. 1 shows schematically the communications network 1 with access nodes 2, 3, 4 (gateways) and internal nodes 5, 6, 7, 8, 9. The access nodes 2, 3, 4 connect the communications network 1 with other networks and terminal devices, each consisting of one ingress node 21, 31, 41 (ingress node) and an egress node 22, 32, 42 (egress node). The internal nodes 5 through 9 serve to forward the data packets from an ingress node 21, 31, 41 to an egress node 22, 32, 42. Which path is taken by a particular data packet is determined by the routing algorithms and adjusted based on the loads of individual nodes. The routing algorithms in particular are known, and need not be described in any greater detail in connection with this invention.

If, for example, an increased traffic demand arises for the internal nodes 5, 6 then the data packets forwarded them are provided with a mark M. Such marks contain, for example, the data packets that are forwarded from ingress node 21 via internal nodes 5, 6 to the egress node 32. If the internal nodes, as well as their connections with one another and with nodes 21 and 32 overloaded, then the data packets to be sent from the ingress node 21 to egress node 32 are routed through the internal nodes 8, 9.

At the egress node 32, the data packets received from ingress node 21 that are marked M are counted for a pre-determined time interval. Also, the bytes and the data packets are counted that are transferred from ingress node 21 to egress node 32 during the pre-determined time interval. The number of marks divided by the number of data packets gives a good measure for the load on the communications network with respect to the transfer between the ingress node 21 and the egress node 32.

For elucidation of the invention, FIG. 2 shows the necessary functions of an ingress node in which at 10 the directing of the data packet to be transferred occurs, and at 11 are classified according to origin and destination (classification per flow). Subsequently, at 12, regulation of their directing to an egress queue 13 (FIFO) output queue) so that a flow of data packets 14 leaves the ingress node. Regulation at 12 is based on the procedure of the token-bucket regulation, whereby tokens are assigned to the individual data packets originally based on origin and destination and combined into a flow, and upon reaching a predetermined token rate, one or more data packets from the particular flow are sent. In FIG. 2, the individual flows are indexed based on their destination and origin. Thus, for example, flow 1.3 means that these data packets are to be transferred to the egress node 32, and arise from an origin indexed as 3 (=participant).

In the known token-bucket regulation, the token rate tnew is calculated by means of the equation tnew=i·r+t, where t is the previous token rate, i is the interval between the current and the previous data packet, and r is the fill rate for the particular token bucket.

Upon application of the invention, the ingress node receives load reports from those egress nodes to which it sends ECT-marked data packets. These reports contain the number m of marks M, the number b of bytes, and the number p of data packets received from an ingress node during a pre-determined time interval. With the help of the values b and m contained therein, the particular token rate tnew is calculated as follows: tnew=i·(b/m)·wtb+t.

In this, wtp is a standard that describes readiness for a higher degree of service quality, i.e., paying a higher price for largely loss-free data transfer. This is by its nature dependent on the particular participant, while b and m from the load report depend only on the degree of network load between a particular ingress node and its corresponding egress node. For the example of an ingress node illustrated in FIG. 2, b and m may therefore applied to all flows indexed with “1.” Thus, in case of arrival of a load report varying from the previous deviating one, the arrival of tokens may be adjusted using a few calculations.

Along with access control designation of the data packets to be sent with an ECT mark that reveals that they are provided for Explicit-Congestion Notification, and that are to be provided with the CE mark upon passage through nodes (CE=congestion experience).

FIG. 2 shows the functions of an egress node (22, 32, 42, FIG. 1) to the extent that it is required to understand the invention. A series 15 of received data packages are directed to the egress node. Some of them contain the CE mark M, and others that have passed through the communications network 1 (FIG. 1) unhindered are not marked. Also, data packets may be received that include no ECT mark. These are not taken into account during subsequent procedure steps. At 17, the data packets are classified per flow so that each of those data packets originating from the same ingress node is statistically identified at a peer at 18. During this, the number n of marks M, the number b of bytes, and the number p of data packets are added together, and are compiled into a load report. The individual data packets are then directed further to their final goal 19.

1. A In a method for controlling access to a communications network with internal nodes and access nodes whereby each of the access nodes comprises an ingress node and an egress node and directs data packets in and out from connected terminal equipment and/or other networks whereby the internal nodes direct the data packets from an ingress node to an egress node according to a routing algorithm, and whereby the internal nodes provide data packets with a load-dependent mark, the improvement wherein the egress nodes count the data packets and the included marks arriving from the communications network separately by ingress node, and form load reports based on the time interval during which the count is performed, and wherein data for controlling access control may be derived from the load reports.

2. Method as in claim 1, wherein a new request is accepted through the access control if the reported load does not exceed a preset threshold value; whereby the request is rejected.

3. Method as in claim 1, wherein load reports are transferred to ingress nodes, and that within an ingress node receiving a particular load report, the number of data packets are limited to the egress node sending the load report.

4. Method as in claim 3, wherein no limitation occurs if the number of marks falls below a pre-determined low threshold value with respect to the number of data packets.

5. Method as in claim 1, wherein data packets arriving from the communications network are controlled in the ingress nodes by means of a token-bucket regulator (TBR) using the parameters bucket depth, filling rate, and peak rate, whereby the token rate is calculated using the previous token rate, the interval between a particular data packet and the previous data packet, and a specified filling rate, characterized in that, a parameter is taken into account during calculation of the token rate that designates the willingness to pay a higher price.

6. Method as in claim 5, wherein data packets that successfully pass the TBR are provided with an ECT mark, while non-registered data packets or an excess of data packets are passed along without ECT marking.

7. Method as in claim 5, wherein the token rate is calculated as follows:
T_{new}=i·s·r+t,
where t is the previous token rate, i is the interval between the current and the previous data packet, s is a value obtained form the load report, and r is a minimum rate.

8. Method as in claim 7, wherein s=(u−e)/l is calculated, where l is the current load estimation, u is a threshold value for the access control, and e is safety margin.

9. Method as in claim 1, wherein the load report is transferred to the particular ingress node within a data packet indicating reservation.

10. Method as in claim 1, wherein the load report at the particular ingress node is transferred within its own data packet.

11. Method as in claim 1, wherein a data rate occurs based on a demand report of an ingress node to an egress node, and subsequently a reservation of a data rate occurs from the egress node, characterized in that the actual data rate is estimated, and that the load estimated for the access control is adjusted depending on the difference between the reserved data rate and the estimated actual data rate.

12. Method as in claim 11, wherein the estimated load is calculated as follows:
l=(m/p)·((a+R)/u),
where l is the estimated load, m and p are the numbers of marks and data packets contained in the load report a is the data rate assignment, R is the demand, and u is the usage rate of the load report derived from the number of bytes and the time-interval information.

13. Method as in claim 12, wherein the adjusted estimated load l* is calculated as follows:
L*=l·[α(c−u)+u]/u
where l is the estimated load along a path, c is the accumulated reserved data rate along this path, and u is the actual measured data rate, and where a determines to what extent the unused data rate (c−u) influences the calculation.

14. Method as in claim 1, wherein a decision is first made regarding marking the data packets dependent on the ECT bit as to which algorithm is used, whereby with the ECT bit set, a rate-oriented algorithm is used, and with an ECT bit not set, a queue-oriented algorithm is applied.

15. Method as in claim 1, wherein the marking rate at internal nodes possesses an exponential relationship to the load, preferably with
m(x)=[exp(k−x)−1]/[exp(k)−1]
for a relative load x and a pre-determined weighting factor of k, and at egress nodes, the average load may be calculated by
L(M)=l(l−root (1−M)),
M is the measured marking rate, n is the designated number of internal nodes on the path, and l is the inverse function of the exponential marking function.

16. Method as in claim 1, wherein the counting further occurs separated by paths, and that the access control is performed, path by path.

17. Method as in claim 1, wherein the separate application to multiple traffic classes.
